(19) United States
(12) Patent Application Publication
(10) Pub. No.: US 2026/0099694 A1
(43) Pub. Date: Apr. 9, 2026

(54) TECHNIQUES FOR IMPROVED USER EXPERIENCE PREDICTION

(71) Applicant: OPTUM, INC., Minnetonka, MN (US)

(72) Inventors: Akshay K. Saxena, Uttar Pradesh (IN); Kamlesh Kumar, Karnataka (IN); Biren Rajdev, Punjab (IN); Ankit Kindra, Delhi (IN); Stephen J. Kelley, Brookline, MA (US)

(21) Appl. No.: 18/909,648

(22) Filed: Oct. 8, 2024

(51) Int. Cl. G06N 3/0442; G06N 20/10

(52) U.S. Cl. CPC G06N 3/0442; G06N 20/10

(57) ABSTRACT

Techniques for improved user experience prediction are disclosed herein. An example computer-implemented method includes receiving a sequence of web pages visited by a user and applying a machine learning model to (i) the sequence of web pages and (ii) a set of metrics data corresponding to the sequence of web pages. Applying the machine learning model includes generating embeddings of web page identifiers associated with the sequence of web pages, determining, by a first hidden layer, a first modified embedding based on respective cross-effects associated with one or more other embeddings, determining, by a second hidden layer, a second modified embedding based on the set of metrics data associated with a respective first modified embedding, and outputting a user experience value for each second modified embedding. The example computer-implemented method further includes generating one or more data objects indicating one or more of the user experience values.

### TECHNICAL FIELD

The present disclosure generally relates to user experience prediction techniques, and more particularly, to accurately predicting user experience values by applying a machine learning model to a sequence of web pages and metrics corresponding to the sequence.

### BACKGROUND

Digital engagement has become a critical metric for evaluating user satisfaction and loyalty across various industries. Traditional methods for gauging digital engagement, such as direct surveys and feedback mechanisms, often suffer from low participation rates. This lack of comprehensive data can hinder an organization's ability to fully understand and enhance the digital experience of its users. Consequently, many entities rely on Net Promoter Scores (NPS) or Likelihood to Recommend (LTR) metrics derived from limited datasets, which often fail to accurately reflect the sentiments of their entire user base.

Moreover, machine learning techniques have been applied to predict user behavior and satisfaction, but these models generally depend on structured data. However, such structured data does not fully capture the complexities/nuances of user interactions in digital environments, such that conventional machine learning models frequently misinterpret user experiences. Thus, despite these efforts, there remains a gap in accurately identifying and quantifying what is commonly referred to as “digital struggle,” or the friction/challenges users face when navigating online platforms.

Therefore, in general, accurate user experience prediction is an area of great interest, and conventional techniques can be insufficient for providing such accurate predictions. Accordingly, a need exists for techniques that provide users with accurate user experience prediction and thereby mitigate the negative effects stemming from inaccurate conventional techniques.

### SUMMARY

In some aspects, the techniques described herein relate to a computer-implemented method including: receiving, at one or more processors, a sequence of web pages visited by a user; applying, by the one or more processors, a machine learning model to (i) the sequence of web pages and (ii) a set of metrics data corresponding to the sequence of web pages, wherein applying the machine learning model includes generating one or more embeddings of web page identifiers associated with the sequence of web pages, determining, by a first hidden layer of the machine learning model and for each respective embedding of the one or more embeddings, a first modified embedding based on respective cross-effects associated with one or more other embeddings of the one or more embeddings, determining, by a second hidden layer of the machine learning model and for each respective first modified embedding, a second modified embedding based on the set of metrics data associated with a respective first modified embedding, and outputting a user experience value for each second modified embedding; and generating, by the one or more processors, one or more data objects indicating one or more of the user experience values.

In some aspects, the techniques described herein relate to a system including: one or more processors; and one or more memories storing processor-executable instructions that, when executed by the one or more processors, cause the one or more processors to perform operations including: receiving a sequence of web pages visited by a user; applying a machine learning model to (i) the sequence of web pages and (ii) a set of metrics data corresponding to the sequence of web pages, wherein applying the machine learning model includes generating one or more embeddings of web page identifiers associated with the sequence of web pages, determining, by a first hidden layer of the machine learning model and for each respective embedding of the one or more embeddings, a first modified embedding based on respective cross-effects associated with one or more other embeddings of the one or more embeddings, determining, by a second hidden layer of the machine learning model and for each respective first modified embedding, a second modified embedding based on the set of metrics data associated with a respective first modified embedding, and outputting a user experience value for each second modified embedding; and generating one or more data objects indicating one or more of the user experience values.

In some aspects, the techniques described herein relate to one or more non-transitory computer-readable media storing processor-executable instructions that, when executed by one or more processors, cause the one or more processors to perform operations including: receiving a sequence of web pages visited by a user; applying a machine learning model to (i) the sequence of web pages and (ii) a set of metrics data corresponding to the sequence of web pages, wherein applying the machine learning model includes generating one or more embeddings of web page identifiers associated with the sequence of web pages, determining, by a first hidden layer of the machine learning model and for each respective embedding of the one or more embeddings, a first modified embedding based on respective cross-effects associated with one or more other embeddings of the one or more embeddings, determining, by a second hidden layer of the machine learning model and for each respective first modified embedding, a second modified embedding based on the set of metrics data associated with a respective first modified embedding, and outputting a user experience value for each second modified embedding; and generating one or more data objects indicating one or more of the user experience values.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present disclosure may be implemented.

FIG. 2A depicts an example user likelihood prediction workflow, in accordance with various embodiments described herein.

FIG. 2B depicts an example embedding generation and user experience value determination workflow, in accordance with various embodiments described herein.

FIG. 2C depicts an example network layer architecture to predict user experience values, in accordance with various embodiments described herein.

FIG. 3 depicts a flow diagram representing an example computer-implemented method, in accordance with various embodiments described herein.

### DETAILED DESCRIPTION

Broadly speaking, the techniques discussed herein leverage a specific machine learning model architecture to process a sequence of web pages visited by a user, along with a set of metrics data corresponding to these web pages. Specifically, the present techniques apply a machine learning model to generate embeddings for the visited web pages, modify these embeddings through multiple hidden layers based on cross-effects between/among web page transitions and associated metrics, and ultimately output a user experience value for each modified embedding. These techniques improve (1) the functioning of a computer by increasing the accuracy of user experience predictions and (2) the field of user sentiment/experience prediction by incorporating highly nuanced user experience data (e.g., web page sequences and metrics data) to determine more accurate experience predictions than was possible using conventional techniques.

As previously mentioned, conventional techniques of gauging user sentiment/experience, such as NPS or LTR, have relied heavily on direct feedback mechanisms like digital surveys. However, these methods face significant limitations due to low response rates and the inability to capture the full spectrum of user interactions and experiences. This gap in understanding user experiences/frustrations presents a critical challenge for entities seeking to optimize their digital platforms and improve user engagement.

Addressing this challenge thus requires looking beyond traditional feedback mechanisms to capture a more comprehensive view of the user experience. The disclosed techniques introduce an innovative solution that leverages and modifies machine learning techniques to predict user sentiment based on their digital interactions. The layered approach of modifying embeddings through the machine learning model, particularly by including cross-effects and relevant metrics, incorporates data that enables a nuanced understanding of user interactions with web pages to better understand how/why a user may have a particular experience across multiple web pages. Thus, these techniques can capture complex patterns of user behavior that traditional analysis methods overlook, leading to more accurate predictions of user experience values, and consequently improving the functioning of the underlying computer.

The techniques of the present disclosure thus improve the functionality of a computing device (e.g., a hosting server such as a central server) at least by analyzing data in a particular way to enhance the accuracy and efficiency of the computing device. The machine learning models, executing on the computing device, determine and utilize modified embeddings to output user experience values with an accuracy not achieved using conventional techniques. That is, the present disclosure describes improvements in the functioning of the computer itself because the computing device more accurately analyzes/utilizes web page data (e.g., web page sequences and corresponding metrics) as a direct result of the machine learning models. This improves over the prior art at least because existing systems ignore such web page sequence and/or metrics data and/or are otherwise unable to analyze the available data with the accuracy resulting from the disclosed machine learning models.

Still further, the present disclosure includes specific features other than what is well-understood, routine, conventional activity in the field, or adding unconventional steps that demonstrate, in various embodiments, particular useful applications, e.g., applying, by the one or more processors, a machine learning model to (i) the sequence of web pages and (ii) a set of metrics data corresponding to the sequence of web pages, wherein applying the machine learning model includes generating one or more embeddings of web page identifiers associated with the sequence of web pages, determining, by a first hidden layer of the machine learning model and for each respective embedding of the one or more embeddings, a first modified embedding based on respective cross-effects associated with one or more other embeddings of the one or more embeddings, determining, by a second hidden layer of the machine learning model and for each respective first modified embedding, a second modified embedding based on the set of metrics data associated with a respective first modified embedding, and/or outputting a user experience value for each second modified embedding, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the health care context, the techniques described herein may be readily applied in any suitable field for any suitable purpose.

### Example Computing System

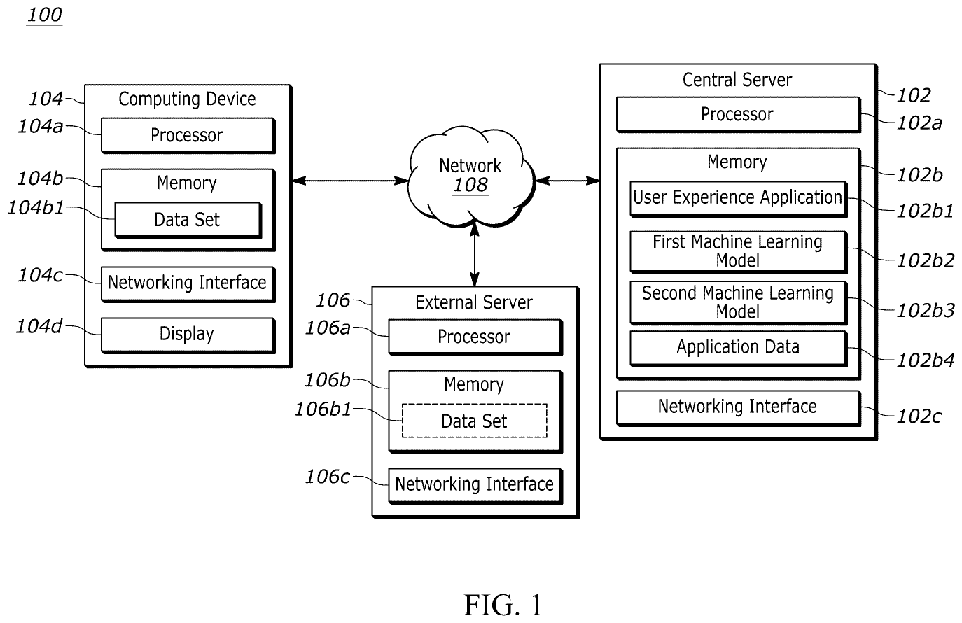

FIG. 1 depicts an example computing system 100 in which various embodiments of the present disclosure may be implemented. Depending on the embodiment, the example computing system 100 may determine/generate web page identifiers, embeddings, modified embeddings, user experience values, data objects, and/or any related values or combinations thereof. Of course, it should be appreciated that, while the various components of the example computing system 100 (e.g., central server 102, computing device 104, external server 106, etc.) are illustrated in FIG. 1 as single components, the example computing system 100 may include multiple (e.g., dozens, hundreds, thousands) of computing devices 104 and external servers 106 that are simultaneously connected to the network 108 at any given time.

Generally, the example computing system 100 includes a central server 102, a computing device 104, and an external server 106. Each of the central server 102, the computing device 104, and the external server 106 may communicate with the other devices (e.g., transmit data, instructions, etc.) across the network 108. As an example, the central server 102 and/or the external server 106 may belong to a healthcare entity (e.g., hospital, health insurance provider, etc.) that collects and analyzes data from one or more websites associated with the healthcare entity, and the computing device 104 may belong to a user accessing a web page or sequence of web pages of the one or more websites. In this example, the user using the computing device 104 may transmit data (e.g., data set 104b1) to the central server 102, and the server 102 may execute a user experience application 102b1 to generate data objects indicating one or more user experience values based on the data set 104b1. The central server 102 may also make the data object accessible to the healthcare entity, so the healthcare entity may review the data object to review the one or more user experience values, update the healthcare entity's website based on the data object, and/or any other suitable actions or combinations thereof.

More specifically, the central server 102 includes one or more processors 102a, the memory 102b, and a networking interface 102c. The memory 102b stores executable instructions that are configured to, when executed by the one or more processors 102a, cause the one or more processors 102a to analyze data (e.g., data set 104b1, 106b1) received at the central server 102 and output various values (e.g., data objects indicating one or more user experience values). The user experience application 102b1, the first machine learning model 102b2, the second machine learning model 102b3, and the application data 102b4 may all include such executable instructions, as well as other data. The memory 102b may also store additional data and/or databases. It should be appreciated that the central server 102 can include one or multiple computing devices that are co-located or distributed. Additionally, in certain embodiments, the user experience application 102b1 includes the first machine learning model 102b2 and/or the second machine learning model 102b3.

The central server 102 receives data set 104b1 from the computing device 104 connected to the server 102 through a network 108 and processes the data set 104b1 in accordance with one or more sets of instructions stored in a memory 102b to output any of the values described herein. The central server 102 executes the user experience application 102b1, which in turn, accesses and applies the first machine learning model 102b2, the second machine learning model 102b3, and/or the application data 102b4 to the data set 102b1. The data set 104b1 generally includes data corresponding to the user's web session, where the user viewed and/or otherwise interacted with various web pages of an entity's website.

As referenced herein, a “web page” is an individual page/interface associated with a website, and a “web session” may generally refer to a set of actions performed by a user when viewing/interacting with a particular set of web pages of a single/multiple websites. For example, a first web session includes a first user loading a first website and viewing and/or interacting with two different web pages of the website (e.g., a home page and a FAQ page of the website), and a second web session includes a second user loading a second website and viewing and/or interacting with five different web pages of the website (e.g., a home page, a user profile page, a bills page, an interactive payment page, a confirmation page).

Thus, the data set 104b1 includes data indicating a sequence of web pages visited/viewed by the user during a web session and/or a set of metrics data corresponding to the sequence of web pages. For example, the sequence of web pages may indicate that a user transitioned from a first web page to a second web page, back to the first web page, and then to a third web page, and the set of metrics data may indicate that the user viewed the first web page for 30 seconds, the second web page for 5 minutes, the first web page for 2 minutes, and then the third web page for 15 minutes. Moreover, the set of metrics data may include any suitable metrics and/or data associated therewith, such as time spent on each web page, exit link flags (e.g., hyperlink clicks) for the web pages, web page load times for each web page, web page proportion (e.g., relative amount of time or interaction a user spends on specific web pages compared to others within the same website) for each web page, and sequences and/or listings of events (e.g., click events, hover events, scroll events, etc.), corresponding to each web page. Some/all of this information may eventually be stored in a user experience database, which may be included as part of the application data 102b4 and/or stored in an external storage location (e.g., external server 106).

The user experience application 102b1 receives the data set 104b1 and generates data objects indicating one or more user experience values by accessing/applying the first machine learning model 102b2 and the second machine learning model 102b3 to the data set 104b1. The user experience values generally indicate/represent a degree of digital struggle users experienced during their respective web sessions based on the sequence of web pages and the corresponding set of metrics data included as part of the data set 104b1. The first machine learning model 102b2 analyzes the sequence of web pages and the set of metrics data of the data set 104b1 to generate embeddings associated with the sequence of web pages and the set of metrics data, modify the web page sequence embeddings based on cross-effects and the metric embeddings, and output user experience values that accurately indicate the degree of digital struggle of a user represented by the sequence of web pages and set of metrics data. With the user experience values, the user experience application 102b1 generates data objects indicating one or more user experience values. The second machine learning model 102b3 then utilizes the user experience values and/or data objects in combination with user demographic data and the set of metrics data to determine a user likelihood value that generally indicates whether the user had a positive, negative, or neutral experience during their web session.

In certain embodiments, the first machine learning model 102b2 includes multiple machine learning models 102b2. For example, the first machine learning model 102b2 may be a long short-term memory (LSTM) network in combination with a transformer model. In particular, the transformer model may generate the embeddings for each of the sequence of web pages and the set of metrics data, and the LSTM network may use these embeddings as inputs to modify the embeddings and output user experience values. In some embodiments, the second machine learning model 102b3 is one or more of (i) a trained random forest model, (ii) a Naïve Bayes model, (iii) a support vector machine (SVM) model, (iv) a logistic regression model, and/or (v) a gradient boosting model.

Moreover, in some embodiments, the first machine learning model 102b2 and/or the second machine learning model 102b3 is stored in a remote location from the central server 102 (e.g., a cloud-based server). In these embodiments, the user experience application 102b1 accesses the trained first machine learning model 102b2 and/or the trained second machine learning model 103b3 by transmitting inputs (e.g., sequence of web pages and set of metrics data, user experience values, data objects) to the cloud-based server. The trained first machine learning model 102b2 and/or the trained second machine learning model 102b3 analyzes the inputs, generates outputs (e.g., modified embeddings, user experience values, user likelihood values), and the cloud-based server returns these outputs to the user experience application 102b1.

More generally, the computing device 104 is or includes any device that is associated with (e.g., owned and/or operated by) a particular entity that may provide data (e.g., data set 104b1) that is transmitted to and/or is otherwise accessible by the central server 102 and/or the external server 106 through the network 108. In certain embodiments, the data set 104b1 transmitted to and/or otherwise accessible by the central server 102 and/or the external server 106 is a sequence of web pages and a set of metrics data associated with a web session of a user of the computing device 104 to be evaluated by the central server 102 and/or the external server 106. In some embodiments, the computing device 104 is a server or collection of servers hosting the data set 104b1. However, in certain embodiments, the computing device 104 is a personal computing device of that entity/user, such as a smartphone, a tablet, smart glasses, or any other suitable device or combination of devices (e.g., a smart watch plus a smartphone) with wireless communication capability. In the embodiment of FIG. 1, the computing device 104 includes a processor 104a, a memory 104b, a networking interface 104c, and a display 104d. The memory 104b stores the data set 104b1.

The computing device 104 is communicatively coupled to the central server 102 and/or the external server 106. For example, the computing device 104, the central server 102, and/or the external server 106 may communicate via any communication/network protocols implemented by the network 108 (e.g., wide area network (WAN), etc.). For example, the computing device 104 may transmit a sequence of web pages, a set of metrics data, and/or any other values or combinations thereof to the central server 102 via the networking interface 104c, which the central server 102 may receive via the networking interface 102c.

The external server 106 may be or include computing servers and/or combinations of multiple servers storing data that may be accessed/retrieved by the central server 102 and/or the computing device 104. In certain embodiments, the external server 106 receives data from the central server 102 and/or the computing device 104 and retrieves/accesses information stored in memory 106b for transmission back to the central server 102 and/or the computing device 104. The external server 106 may include a processor 106a, a memory 106b, and a networking interface 106c. It should be appreciated that the external server 106 can include one or multiple computing devices that are co-located or distributed.

Further, in certain embodiments, the external server 106 includes a data set 106b1 including data from the computing device 104 and/or the central server 102. In one such example, the external server 106 is a server located in and/or otherwise associated with a hospital or other healthcare entity (e.g., health insurance provider), and the data set 106b1 includes user likelihood records in memory 106b. As another example, the external server 106 serves as a database for some or all of the application data 102b4. In some embodiments, the example computing system 100 does not include the external server 106.

Each of the processors 102a, 104a, 106a may include any suitable number of processors and/or processor types. For example, the processors 102a, 104a, 106a may each include one or more CPUs and one or more graphics processing units (GPUs). Generally, each of the processors 102a, 104a, 106a may be configured to execute software instructions stored in each of the corresponding memories 102b, 104b, 106b. The memories 102b, 104b, 106b may each include one or more persistent memories (e.g., a hard drive and/or solid state memory) and may store one or more applications, modules, and/or models, such as the user experience application 102b1.

The networking interface 102c may enable the central server 102 to communicate with the computing device 104, the external server 106, and/or any other suitable devices or combinations thereof. More specifically, the networking interface 102c enables the central server 102 to communicate with each component of the example computing system 100 across the network 108 through their respective networking interfaces 104c, 106c. The networking interfaces 102c, 104c, 106c support one or more of the communication/network protocols implemented by the network 108. The networking interface 102c may enable the central server 102 to communicate with the various components of the example computing system 100 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

Moreover, the network 108 may be a single communication network, or may include multiple communication networks of one or more types (e.g., one or more wired and/or PANs or LANs, and/or one or more WANs such as the Internet). In some embodiments, the network 108 includes multiple, entirely distinct networks (e.g., one or more networks for communications between central server 102 and computing device 104, and a separate, Bluetooth or wireless LAN (WLAN) network for communications between central server 102 and computing device 104, and so on).

It will be understood that the above disclosure is one example and does not necessarily describe every possible embodiment. As such, it will be further understood that alternate embodiments may include fewer, alternate, and/or additional steps or elements.

### Example User Experience and User Likelihood Value Workflows

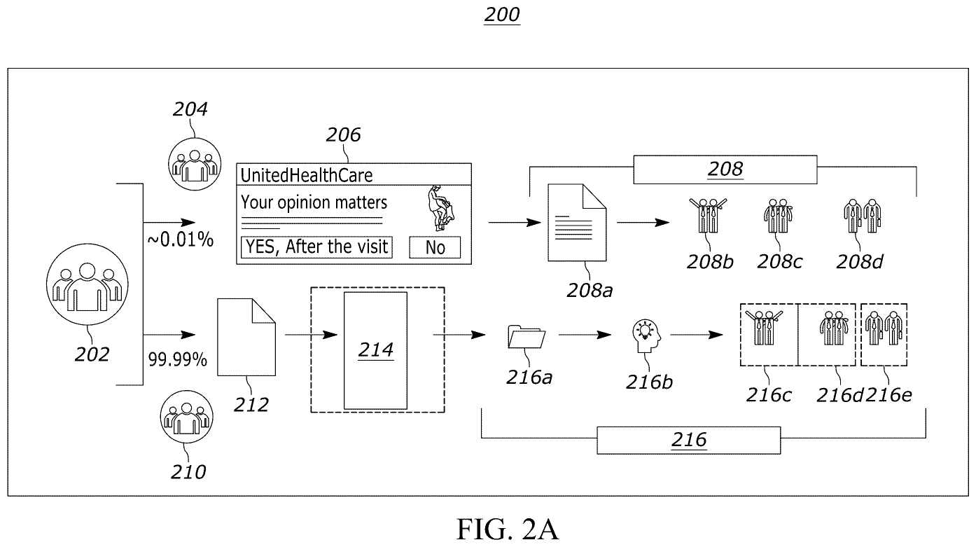

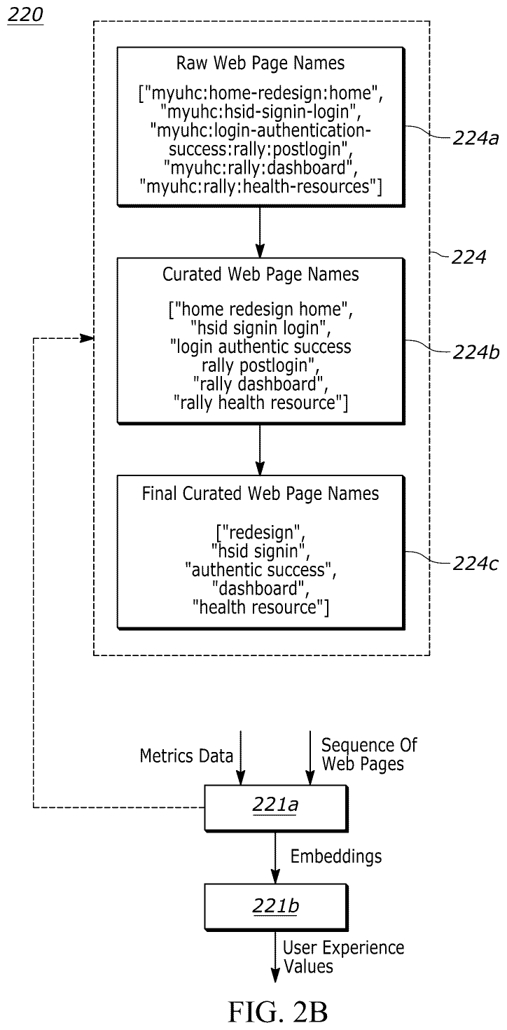

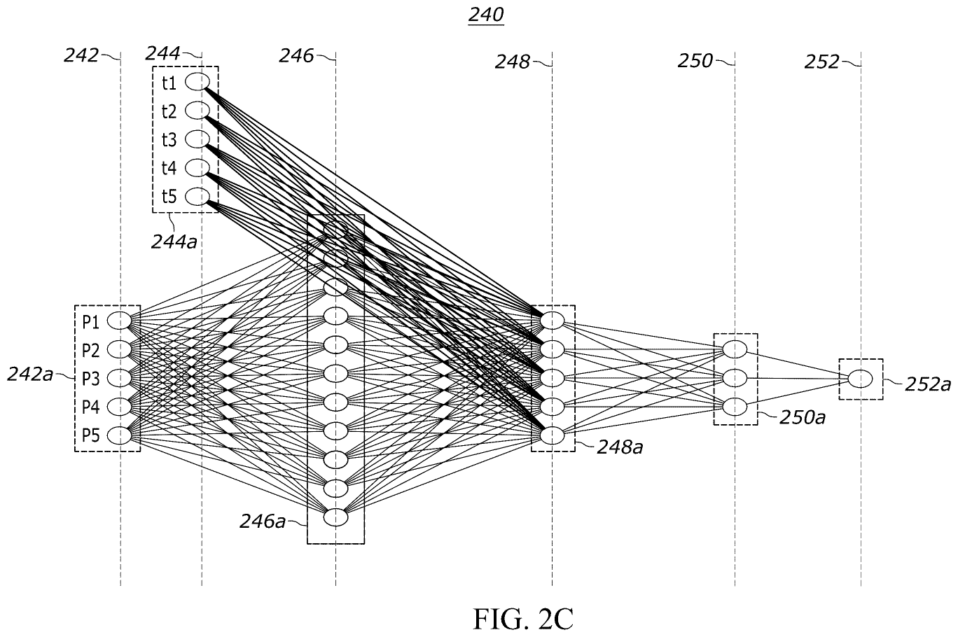

FIG. 2A depicts an example user likelihood prediction workflow 200, in accordance with various embodiments described herein. The example user likelihood prediction workflow 200 broadly illustrates a sequence of actions, which may be performed by central server 102 (e.g., processor 102a and/or other components of central server 102) of FIG. 1, for example, to generate/determine embeddings, modified embeddings, user experience values, data objects, and/or user likelihood values. The example dynamic data validation workflow 200 illustrated in FIG. 2A is for the purposes of discussion only, and additional/alternative user likelihood prediction sequences may also, or instead, be utilized.

The example user likelihood prediction workflow 200 includes a user 202 conducting a web session where the user 202 interacts with one or more web pages of a website. When the user 202 concludes the web session, the systems herein (e.g., user experience application 102b1) may present the user 202 with a prompt requesting the user 202 to respond to a digital survey. The digital survey generally includes questions or other prompts relating to the user's 202 experience during their web session, and the system may present the digital survey to users 204 that choose to respond to the digital survey (block 206). When the user 204 completes and submits the digital survey, the results are analyzed in a sequence broadly represented by the set of actions 208. Namely, the user's 204 digital survey results are received (block 208a) and analyzed to determine a type of experience (208b, 208c, 208d) the user 204 had during their web session. These user experience categorizations 208b, 208c, 208d generally correspond to the user likelihood values described herein.

For example, the digital survey results may indicate that a user 204 was completely satisfied with the clarity and layout of the website, such that the system determines the user 204 had a positive experience, as represented by the first user experience categorization 208b. As another example, the digital survey results may indicate that a user 204 had a frustrating experience with the website and was unable to resolve and/or otherwise achieve whatever purpose the user 204 had when visiting the website. In this experience, the system may determine that the user 204 had a negative experience, as represented by the third user experience categorization 208d. In certain embodiments, the first user experience categorization 208b corresponds to a promoter categorization, the second user experience categorization 208c corresponds to a passive categorization, and the third user experience categorization 208d corresponds to a detractor categorization.

As indicated in FIG. 2A, users 204 choosing to respond to the digital survey generally represent a relatively low percentage of all users 202 that visit the website (e.g., approximately 0.01% of all users). Accordingly, the user experience data acquired through this direct response path (e.g., blocks 204-208) is generally under representative of the collective user experience when interacting with the website. To supplement the relatively small amount of data acquired through the direct response path, a user experience application (e.g., 102b1) receives a sequence of web pages and/or a set of metrics data associated with the web sessions of users 210 that choose not to respond to the survey (block 212) for analysis using the machine learning techniques described herein.

At block 214, the system analyzes the sequence of web pages and/or the set of metrics data to determine a user experience value. As mentioned, the user experience value generally indicates a degree or level of digital struggle the user 210 experienced during the web session represented by the sequence of web pages and set of metrics data. For example, the user experience value may indicate that the user 210 experienced a relatively small amount of digital struggle during their web session, based on the sequence of web pages indicating the user 210 visited two web pages and the set of metrics data indicating that the user 210 spent a total of 5 minutes on the website.

In any event, the system may output this user experience value for analysis in a sequence broadly represented by the set of actions 216. At block 216a, the system receives the user experience value and any other structured data corresponding to the user 210, such as demographic data, the set of metrics data, and/or any other values/metrics or combinations thereof. At block 216b, the system (e.g., second machine learning model 102b3) analyzes these inputs to determine a user likelihood value. The user likelihood value generally indicates one or more of the user experience categorizations 216c, 216d, 216e, which may be similar/identical to the user experience categorizations 208b, 208c, 208d.

Continuing the prior example, the user likelihood value may indicate that the user 210 had a positive experience during their web session, as represented by the first user experience categorization 216c. As another example, the user likelihood value may indicate that the user 210 had a relatively neutral experience during their web session, as represented by the second user experience categorization 216d. In certain embodiments, the first user experience categorization 216c corresponds to the promoter categorization, the second user experience categorization 216d corresponds to the passive categorization, and the third user experience categorization 216e corresponds to the detractor categorization.

FIG. 2B depicts an example embedding generation and user experience value determination workflow 220 that illustrates the actions performed as part of block 214 in FIG. 2A, in accordance with various embodiments described herein. The input of the workflow 220 is a sequence of web pages and a set of metrics data, and the output of the workflow 220 is one or more user experience values. Any of the actions/steps described with reference to FIG. 2B may be performed by central server 102 (e.g., processor 102a and/or other components of central server 102) of FIG. 1, and/or any other suitable processor or combinations thereof.

The workflow 220 includes receiving a sequence of web pages and a set of metrics data. At block 221a, the workflow 220 includes (1) performing data curation of the sequence of web pages and set of metrics data to identify web page types corresponding to the sequence of web pages visited/viewed by the user during their web session and (2) generating embeddings for each of the sequence of web pages, the set of metrics data, and/or the curated web page names/types. The sequence of web pages may include, for example, a listing of resource identifiers (e.g., uniform resource locators (URLs)) corresponding to each web page. This listing is generally ordered sequentially in terms of the user's viewing sequence of web pages during their web session, but in certain embodiments, may be an un-ordered or otherwise ordered (e.g., alphabetical) list including all web pages the user visited during their web session. The data curation performed at block 221a identifies additional information included as part of the sequence of web pages and/or set of metrics data that can inform the user experience value determination. For example, processing, transforming and/or otherwise curating the web page names (block 224) provides additional insights into the types of web pages the user visited during their web session, which further informs the type of experience the user likely had during their web session.

Block 221a generally includes one or more machine learning models configured/trained to perform the embedding generation and the data curation. In certain embodiments, the machine learning model configured to generate the embeddings (e.g., first machine learning model 102b2) may also perform the data curation, for example, by pre-processing and transforming the resource identifiers into curated web page names (block 224).

The example illustrated in block 224 includes a sequence of web page resource identifiers, depicted as raw web page names 224a. For example, a first raw web page name is the URL “myuhc:home-redesign:home”, and a second raw web page name is the URL “myuhc:hsid-signin-login.” The processing performed as part of block 221a includes taking these raw web page names 224a and pre-processing them into a set of curated web page names 224b. This curation includes natural language processing (NLP) functionality, such as stop-word removal, stemming/lemmatization, special character removal, and/or any other techniques or combinations thereof. As a result, the raw web page names 224a are adjusted to the curated web page names 224b, such as changing the first raw web page name from “myuhc:home-redesign: home” to “home redesign home,” and changing the second raw web page name from “myuhc:hsid-signin-login” to “hsid signin login.”

The workflow 220 at block 224 further includes transforming the curated web page names 224b into final curated web page names 224c. These final curated web page names 224c generally represent unique and/or otherwise distinct web page names resulting from common word/term removal from the curated web page names 224b. The systems described herein may perform common words removal on each of the curated web page names 224b using any suitable transformation method, such as the term frequency-inverse document frequency (tf-idf) method. As an example, using the transformation method, the first curated web page name is transformed from “home redesign home” to “redesign,” and the second curated web page name is transformed from “hsid signin login” to “hsid signin.”

The embeddings generated at block 221a are generally based on the sequence of web pages (e.g., raw web page names 224a) and the set of metrics received at block 221a. In certain embodiments, the embeddings may also be or include embeddings of the curated web page names 224b and/or the final curated web page names 224c. For example, the workflow 220 at block 221a may include generating, by a transformer model, one or more embeddings associated with the sequence of web pages, the set of metrics data, and/or web page names/types identified/generated as a result of the analysis performed at block 224.

The workflow 220 further includes determining user experience values at block 221b. Generally, this determination includes determining multiple modified embeddings by evaluating (1) cross-effects between/among web page sequence embeddings and (2) effects of the set of metrics data embeddings on the web page sequence embeddings. Block 221b includes determining, for each respective embedding of the web page sequence embeddings, a modified embedding (also referenced herein as a “first modified embedding”) based on respective cross-effects associated with one or more other web page sequence embeddings. Block 221b also includes determining, for each respective first modified embedding, another modified embedding (also referenced herein as a “second modified embedding”) based on the set of metrics embeddings that corresponding with the first modified embedding (e.g., the web page(s) represented by the first modified embedding). Block 221b further includes reducing the dimension of these second modified embeddings to output the user experience value. For example, the systems described herein may reduce the second modified embedding(s) dimension at block 221b through multiple dense layers of a machine learning model, such as by applying a sigmoid activation function.

More generally, the machine learning functions described herein are implemented through machine learning methods and algorithms. In certain embodiments, the machine learning model(s) utilized as part of block 221a and/or block 221b is or includes an LSTM network (or other suitable RNNs or other models) and/or a transformer model (e.g., BERT model) configured to determine embeddings and user experience values based on sequences of web pages and sets of metric data. In some embodiments, the machine learning model(s) utilized as part of the user likelihood value determinations is or includes a trained random forest model configured to receive user experience values, demographic data, sets of metrics data, and/or other data to determine the user likelihood values.

In certain embodiments, the machine learning models described herein (e.g., second machine learning model 102b3 and/or first machine learning model 102b2) employ supervised learning, which involves identifying patterns in existing data to make predictions about subsequently received data. Specifically, the machine learning models may be “trained” using training data, which includes example inputs and associated example outputs. Based upon the training data, the machine learning models generate a predictive function which maps outputs to inputs and utilize the predictive function to generate machine learning outputs based upon data inputs. The example inputs and example outputs of the training data may include any of the data inputs or machine learning outputs described above. In the exemplary embodiment, a processing element may be trained by providing it with a large sample of data with known characteristics or features. In various embodiments, the implemented machine learning methods and algorithms are directed toward at least one of a plurality of categorizations of machine learning, such as supervised learning.

In some embodiments, the machine learning models described herein (e.g., first machine learning model 102b2 and/or second machine learning model 102b3) employ unsupervised learning, which involves finding meaningful relationships in unorganized data. Unlike supervised learning, unsupervised learning does not involve user-initiated training based upon example inputs with associated outputs/labels. Rather, in unsupervised learning, the machine learning model organizes unlabeled data according to a relationship determined by at least one machine learning method/algorithm employed by the machine learning model. Unorganized data may include any combination of data inputs and/or machine learning outputs, as described above.

Additionally, or alternatively, the machine learning models described herein may utilize or include natural language processing (NLP) functionality. For example, the sequence of web pages generally includes web page names, and the machine learning model(s) described herein (e.g., first machine learning model 102b2) may implement NLP algorithms/models to interpret the text included therein when determining the user experience values and/or user likelihood values.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the machine learning models described herein may be used to output user experience values, embeddings, modified embeddings, user likelihood values, data objects, and/or any other values, outputs, or combinations thereof using artificial intelligence (e.g., a machine learning model of the first machine learning model 102b2) or, in alternative aspects, without using artificial intelligence.

FIG. 2C depicts an example network layer architecture 240 to predict user experience values, in accordance with various embodiments described herein. The example network layer architecture 240 generally is an LSTM network that includes multiple layers 242-252 that each include a set of embeddings (i.e., vectors) and/or represent one or more actions/functions performed using the sets of embeddings. For example, the first layer 242 includes a first set of embeddings 242a, the second layer 244 includes a second set of embeddings 244a, the third layer 246 includes a third set of embeddings 246a, the fourth layer 248 includes a fourth set of embeddings 248a, the fifth layer 250 includes a fifth set of embeddings 250a, and the output layer 252 includes an output embedding 252a. It should be appreciated that the sets of embeddings described in reference to FIG. 2C are vectors that have shape/dimensions that may be modified as a result of operations performed at the various layers 242-252.

The first layer 242 is an input layer of the example network layer architecture 240 for receiving the first set of embeddings 242a from a transformer model and/or other model/algorithm configured to generate the first set of embeddings 242a. Each embedding (e.g., “P1”, “P2”, etc.) illustrated in the first set of embeddings 242a generally represents or corresponds to a web page identifier/name, for example, as generated during the data curation (block 224) described herein in reference to FIG. 2B. In certain embodiments, the first set of embeddings 242a are zero padded vectors of BERT embeddings of shape/dimension (None, 512, 768).

The second layer 244 is another input layer of the example network layer architecture 240 for receiving the second set of embeddings 244a from the transformer model and/or other model/algorithm configured to generate the second set of embeddings 244a. Each embedding (e.g., “t1”, “t2”, etc.) illustrated in the second set of embeddings 244a generally represents or corresponds to a specific metric of the set of metrics, for example, the time spent on a corresponding web page. Namely, the “t1” embedding in the second set of embeddings 244a indicates/represents the amount of time a user spent on the web page indicated by the “P1” embedding in the first set of embeddings 242a, the “t2” embedding in the second set of embeddings 244a indicates/represents the amount of time a user spent on the web page indicated by the “P2” embedding in the first set of embeddings 242a, and so on. In certain embodiments, the second set of embeddings 244a are zero padded vectors of shape (None, 512).

In certain embodiments, the example network layer architecture 240 includes three or more input layers. For example, the architecture 240 may include the first layer 242 with the web page sequence embeddings (first set of embeddings 242a), the second layer 244 with the time spent embeddings (second set of embeddings 244a), and a plurality of other input layers (not shown) each with a set of embeddings corresponding to a sequence of web page proportions, a sequence of events corresponding with respective web pages of the sequence of web pages, a set of web page load times, and/or a set of exit flag links, respectively.

The third layer 246 is a hidden layer of the example network layer architecture 240 where the network absorbs the first set of embeddings 242a and outputs a third set of embeddings 246a of shape (None, 512). In particular, the third layer 246 includes determining cross-effects of each embedding from the first set of embeddings 242a on every other embedding of the first set of embeddings 242a. Generally, there is (or may be) a causal effect/influence on the user's experience or digital struggle during their web session that can be inferred from particular transitions between certain web pages (e.g., transitioning from a payment information entry page to the home page without the user viewing a payment receipt confirmation page in between). By performing this cross-effect evaluation at the third layer 246, the third layer 246 modifies the individual embeddings of the first layer 242 to incorporate these causal effects, such that the third set of embeddings 246a more accurately reflect the effect/influence each web page transition may have had on the user's experience during their web session.

The fourth layer 248 is a second hidden layer of the example network layer architecture 240 that receives the third set of embeddings 246a from the third layer 246 and the second set of embeddings 244a from the second layer 244 and outputs a fourth set of embeddings 248a of shape (None, 512). The fourth layer 248 modifies the third set of embeddings 246a by multiplying the third set of embeddings 246a with the second set of embeddings 244a. Similar to the transitions between web pages, there is (or may be) a causal effect/influence on the user's experience or digital struggle during their web session that can be inferred from the metrics data corresponding to each web page. For example, a user spending 15 minutes on a payment information entry web page may indicate that the user experienced significant digital struggle when attempting to enter payment information. Thus, when the fourth layer 248 modifies the third set of embeddings 246a by multiplying them with the second set of embeddings 244a, the fourth set of embeddings 248a incorporate these effects/influences and more accurately reflect/represent the impact of each web page during the user's web session.

In certain embodiments, the example network layer architecture 240 includes a plurality of hidden layers similar to the fourth layer 248 to multiply and/or otherwise modify the third set of embeddings 246a with any suitable number of sets of input embeddings (e.g., the second set of embeddings 244a), and thereby incorporate effects/influences associated with any suitable metrics. For example, another hidden layer (not shown) may multiply the fourth set of embeddings 248a with another set of input embeddings (e.g., a set of embeddings corresponding to a sequence of web page proportions) to output another set of modified embeddings for receipt at the fifth layer 250. In some embodiments, the fourth layer 248 may modify the third set of embeddings 246a by multiplying the third set of embeddings 246a with any suitable number of sets of input embeddings (e.g., the second set of embeddings 244a and a set of embeddings corresponding to a sequence of web page proportions).

The fifth layer 250 is a third hidden layer of the example network layer architecture 240 that receives the fourth set of embeddings 248a from the fourth layer 248 and outputs a fifth set of embeddings 250a of shape (None, 64). Thus, the fifth layer 250 generates a set of reduced dimension embeddings (e.g., fifth set of embeddings 250a) that are received at the output layer 252. The output layer 252 receives the fifth set of embeddings 250a from the fifth layer 250 and generates the user experience value in the form of the output embedding 252a. In certain embodiments, both the fifth layer 250 and the output layer 252 are dense layers. Moreover, in some embodiments, the output layer 252 is configured to output the user experience value (e.g., output embedding 252a) by applying a sigmoid activation function, which applies a non-linear transformation to each element of the input vector (output embedding 252a), mapping it to a value between 0 and 1. Of course, the output layer 252 may output the user experience value by using any suitable function or combinations thereof, such as a softmax activation function and/or a linear activation function.

### Example Computer-Implemented Methods

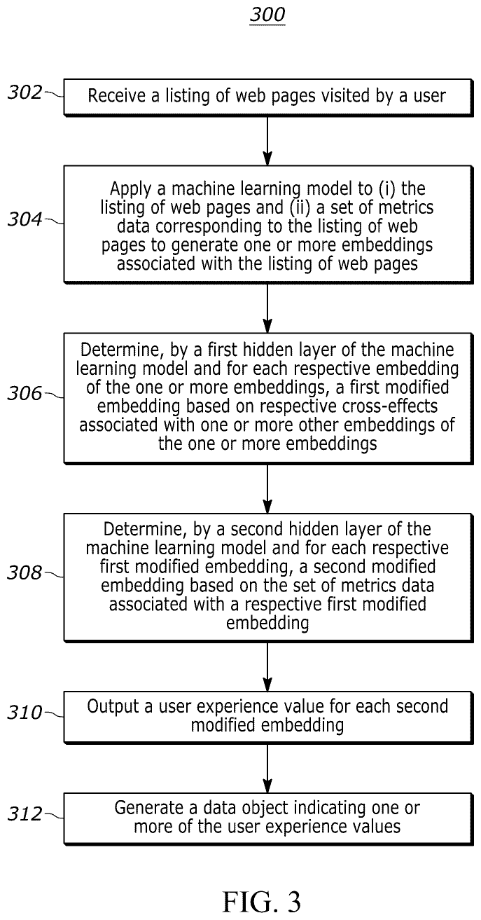

FIG. 3 depicts a flow diagram representing an example computer-implemented method 300, in accordance with various embodiments described herein. The method 300 may be implemented by one or more processors of the example computing system 100, such as the processor 102a of central server 102 (e.g., by user experience application 102b1), for example.

The method 300 includes receiving, at one or more processors, a sequence of web pages visited by a user (block 302). The method 300 further includes applying a machine learning model to (i) the sequence of web pages and (ii) a set of metrics data corresponding to the sequence of web pages, wherein applying the machine learning model includes generating one or more embeddings of web page identifiers associated with the sequence of web pages (block 304). The method 300 further includes determining, by a first hidden layer of the machine learning model and for each respective embedding of the one or more embeddings, a first modified embedding based on respective cross-effects associated with one or more other embeddings of the one or more embeddings (block 306).

The method 300 further includes determining, by a second hidden layer of the machine learning model and for each respective first modified embedding, a second modified embedding based on the set of metrics data associated with a respective first modified embedding (block 308). The method 300 further includes outputting a user experience value for each second modified embedding (block 310). The method 300 further includes generating one or more data objects indicating one or more of the user experience values (block 312).

In certain embodiments, the machine learning model is a long short-term memory (LSTM) network in combination with a transformer model. In these embodiments, the first hidden layer and the second hidden layer are associated with the LSTM network, and applying the machine learning model further includes: generating, by the transformer model, the one or more embeddings associated with the sequence of web pages.

In some embodiments, applying the machine learning model further includes: determining, by a third hidden layer, a reduced dimension embedding for each second modified embedding, wherein the third hidden layer is a dense layer.

In certain embodiments, applying the machine learning model further includes: outputting, by an output layer, the user experience value for each second modified embedding by applying a sigmoid function, wherein the output layer is a dense layer.

In some embodiments, the machine learning model is a first machine learning model, and the method 300 further includes: applying, by the one or more processors, a second machine learning model to (i) the user experience value, (ii) demographic data, and (iii) the set of metrics data corresponding to the sequence of web pages to output a user likelihood value.

In certain embodiments, the second machine learning model is one or more of: (i) a trained random forest model, (ii) a Naïve Bayes model, (iii) a support vector machine (SVM) model, (iv) a logistic regression model, and/or (v) a gradient boosting model.

In some embodiments, the set of metrics data is a vector associated with an input layer to the machine learning model.

In certain embodiments, the set of metrics data includes (i) a first vector associated with a first input layer and (ii) a second vector associated with a second input layer, wherein the first vector corresponds to a first metric, and wherein the second vector corresponds to a second metric that is different from the first metric.

In some embodiments, the set of metrics data includes: (i) a sequence of time spent, (ii) a sequence of web page proportion, (iii) a sequence of events corresponding with respective web pages of the sequence of web pages, (iv) a set of web page load times, and/or (v) a set of exit link flags.

Of course, it is to be appreciated that the actions of the method 300 may be performed any suitable number of times, and that the actions described in reference to the method 300 may be performed in any suitable order.

### EXAMPLES

Example 1. A computer-implemented method comprising: receiving, at one or more processors, a sequence of web pages visited by a user; applying, by the one or more processors, a machine learning model to (i) the sequence of web pages and (ii) a set of metrics data corresponding to the sequence of web pages, wherein applying the machine learning model includes generating one or more embeddings of web page identifiers associated with the sequence of web pages, determining, by a first hidden layer of the machine learning model and for each respective embedding of the one or more embeddings, a first modified embedding based on respective cross-effects associated with one or more other embeddings of the one or more embeddings, determining, by a second hidden layer of the machine learning model and for each respective first modified embedding, a second modified embedding based on the set of metrics data associated with a respective first modified embedding, and outputting a user experience value for each second modified embedding; and generating, by the one or more processors, one or more data objects indicating one or more of the user experience values.

Example 2. The computer-implemented method of example 1, wherein the machine learning model is a long short-term memory (LSTM) network in combination with a transformer model.

Example 3. The computer-implemented method of example 2, wherein the first hidden layer and the second hidden layer are associated with the LSTM network, and applying the machine learning model further includes: generating, by the transformer model, the one or more embeddings associated with the sequence of web pages.

Example 4. The computer-implemented method of any of examples 1-3, wherein applying the machine learning model further includes: determining, by a third hidden layer, a reduced dimension embedding for each second modified embedding, wherein the third hidden layer is a dense layer.

Example 5. The computer-implemented method of any of examples 1-4, wherein applying the machine learning model further includes: outputting, by an output layer, the user experience value for each second modified embedding by applying a sigmoid function, wherein the output layer is a dense layer.

Example 6. The computer-implemented method of any of examples 1-5, wherein the machine learning model is a first machine learning model, and the computer-implemented method further comprises: applying, by the one or more processors, a second machine learning model to (i) the user experience value, (ii) demographic data, and (iii) the set of metrics data corresponding to the sequence of web pages to output a user likelihood value.

Example 7. The computer-implemented method of example 6, wherein the second machine learning model is one or more of: (i) a trained random forest model, (ii) a Naïve Bayes model, (iii) a support vector machine (SVM) model, (iv) a logistic regression model, or (v) a gradient boosting model.

Example 8. The computer-implemented method of any of examples 1-7, wherein the set of metrics data is a vector associated with an input layer to the machine learning model.

Example 9. The computer-implemented method of example 8, wherein the set of metrics data includes (i) a first vector associated with a first input layer and (ii) a second vector associated with a second input layer, wherein the first vector corresponds to a first metric, and wherein the second vector corresponds to a second metric that is different from the first metric.

Example 10. The computer-implemented method of any of examples 1-9, wherein the set of metrics data includes: (i) a sequence of time spent, (ii) a sequence of web page proportion, (iii) a sequence of events corresponding with respective web pages of the sequence of web pages, (iv) a set of web page load times, or (v) a set of exit link flags.

Example 11. A system comprising one or more processors; and one or more memories storing processor-executable instructions that, when executed by the one or more processors, cause the one or more processors to perform operations including: receiving a sequence of web pages visited by a user; applying a machine learning model to (i) the sequence of web pages and (ii) a set of metrics data corresponding to the sequence of web pages, wherein applying the machine learning model includes generating one or more embeddings of web page identifiers associated with the sequence of web pages, determining, by a first hidden layer of the machine learning model and for each respective embedding of the one or more embeddings, a first modified embedding based on respective cross-effects associated with one or more other embeddings of the one or more embeddings, determining, by a second hidden layer of the machine learning model and for each respective first modified embedding, a second modified embedding based on the set of metrics data associated with a respective first modified embedding, and outputting a user experience value for each second modified embedding; and generating one or more data objects indicating one or more of the user experience values.

Example 12. The system of example 11, wherein the machine learning model is a long short-term memory (LSTM) network in combination with a transformer model.

Example 13. The system of example 12, wherein the first hidden layer and the second hidden layer are associated with the LSTM network, and applying the machine learning model further includes: generating, by the transformer model, the one or more embeddings associated with the sequence of web pages.

Example 14. The system of any of examples 11-13, wherein applying the machine learning model further includes: determining, by a third hidden layer, a reduced dimension embedding for each second modified embedding, wherein the third hidden layer is a dense layer.

Example 15. The system of any of examples 11-14, wherein applying the machine learning model further includes: outputting, by an output layer, the user experience value for each second modified embedding by applying a sigmoid function, wherein the output layer is a dense layer.

Example 16. The system of any of examples 11-15, wherein the machine learning model is a first machine learning model, and the instructions, when executed by the one or more processors, further cause the one or more processors to perform operations comprising: applying a second machine learning model to (i) the user experience value, (ii) demographic data, and (iii) the set of metrics data corresponding to the sequence of web pages to output a user likelihood value.

Example 17. The system of example 16, wherein the second machine learning model is one or more of: (i) a trained random forest model, (ii) a Naïve Bayes model, (iii) a support vector machine (SVM) model, (iv) a logistic regression model, or (v) a gradient boosting model.

Example 18. The system of any of examples 11-17, wherein the set of metrics data is a vector associated with an input layer to the machine learning model.

Example 19. The system of example 18, wherein the set of metrics data includes (i) a first vector associated with a first input layer and (ii) a second vector associated with a second input layer, wherein the first vector corresponds to a first metric, and wherein the second vector corresponds to a second metric that is different from the first metric.

Example 20. One or more non-transitory computer-readable media storing processor-executable instructions that, when executed by one or more processors, cause the one or more processors to perform operations comprising: receiving a sequence of web pages visited by a user; applying a machine learning model to (i) the sequence of web pages and (ii) a set of metrics data corresponding to the sequence of web pages, wherein applying the machine learning model includes generating one or more embeddings of web page identifiers associated with the sequence of web pages, determining, by a first hidden layer of the machine learning model and for each respective embedding of the one or more embeddings, a first modified embedding based on respective cross-effects associated with one or more other embeddings of the one or more embeddings, determining, by a second hidden layer of the machine learning model and for each respective first modified embedding, a second modified embedding based on the set of metrics data associated with a respective first modified embedding, and outputting a user experience value for each second modified embedding; and generating one or more data objects indicating one or more of the user experience values.

Example 21. The one or more non-transitory computer-readable storage media of example 20, wherein the machine learning model is a long short-term memory (LSTM) network in combination with a transformer model.

Example 22. The one or more non-transitory computer-readable storage media of example 21, wherein the first hidden layer and the second hidden layer are associated with the LSTM network, and applying the machine learning model further includes: generating, by the transformer model, the one or more embeddings associated with the sequence of web pages.

Example 23. The one or more non-transitory computer-readable storage media of any of examples 20-22, wherein applying the machine learning model further includes: determining, by a third hidden layer, a reduced dimension embedding for each second modified embedding, wherein the third hidden layer is a dense layer.

Example 24. The one or more non-transitory computer-readable storage media of any of examples 20-23, wherein applying the machine learning model further includes: outputting, by an output layer, the user experience value for each second modified embedding by applying a sigmoid function, wherein the output layer is a dense layer.

Example 25. The one or more non-transitory computer-readable storage media of any of examples 20-24, wherein the machine learning model is a first machine learning model, and the instructions, when executed by the one or more processors, further cause the one or more processors to perform operations comprising: applying a second machine learning model to (i) the user experience value, (ii) demographic data, and (iii) the set of metrics data corresponding to the sequence of web pages to output a user likelihood value.

Example 26. The one or more non-transitory computer-readable storage media of example 25, wherein the second machine learning model is one or more of: (i) a trained random forest model, (ii) a Naïve Bayes model, (iii) a support vector machine (SVM) model, (iv) a logistic regression model, or (v) a gradient boosting model.

Example 27. The one or more non-transitory computer-readable storage media of any of examples 20-26, wherein the set of metrics data is a vector associated with an input layer to the machine learning model.

Example 28. The one or more non-transitory computer-readable storage media of example 27, wherein the set of metrics data includes (i) a first vector associated with a first input layer and (ii) a second vector associated with a second input layer, wherein the first vector corresponds to a first metric, and wherein the second vector corresponds to a second metric that is different from the first metric.

Example 29. The computer-implemented method of Example 1, wherein training of the machine learning model is performed by the one or more processors.

Example 30. The computer-implemented method of Example 1, wherein: the one or more processors are included in a first computing entity; and training of the machine learning model is performed by one or more processors included in a second computing entity.

### Additional Considerations

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
receiving, at one or more processors, a sequence of web pages visited by a user;
applying, by the one or more processors, a machine learning model to (i) the sequence of web pages and (ii) a set of metrics data corresponding to the sequence of web pages, wherein applying the machine learning model includes
generating one or more embeddings of web page identifiers associated with the sequence of web pages,
determining, by a first hidden layer of the machine learning model and for each respective embedding of the one or more embeddings, a first modified embedding based on respective cross-effects associated with one or more other embeddings of the one or more embeddings,
determining, by a second hidden layer of the machine learning model and for each respective first modified embedding, a second modified embedding based on the set of metrics data associated with a respective first modified embedding, and
outputting a user experience value for each second modified embedding; and
generating, by the one or more processors, one or more data objects indicating one or more of the user experience values.

2. The computer-implemented method of claim 1, wherein the machine learning model is a long short-term memory (LSTM) network in combination with a transformer model.

3. The computer-implemented method of claim 2, wherein the first hidden layer and the second hidden layer are associated with the LSTM network, and applying the machine learning model further includes:
generating, by the transformer model, the one or more embeddings associated with the sequence of web pages.

4. The computer-implemented method of claim 1, wherein applying the machine learning model further includes:
determining, by a third hidden layer, a reduced dimension embedding for each second modified embedding, wherein the third hidden layer is a dense layer.

5. The computer-implemented method of claim 1, wherein applying the machine learning model further includes:
outputting, by an output layer, the user experience value for each second modified embedding by applying a sigmoid function, wherein the output layer is a dense layer.

6. The computer-implemented method of claim 1, wherein the machine learning model is a first machine learning model, and the computer-implemented method further comprises:
applying, by the one or more processors, a second machine learning model to (i) the user experience value, (ii) demographic data, and (iii) the set of metrics data corresponding to the sequence of web pages to output a user likelihood value.

7. The computer-implemented method of claim 6, wherein the second machine learning model is one or more of: (i) a trained random forest model, (ii) a Naïve Bayes model, (iii) a support vector machine (SVM) model, (iv) a logistic regression model, or (v) a gradient boosting model.

8. The computer-implemented method of claim 1, wherein the set of metrics data is a vector associated with an input layer to the machine learning model.

9. The computer-implemented method of claim 8, wherein the set of metrics data includes (i) a first vector associated with a first input layer and (ii) a second vector associated with a second input layer, wherein the first vector corresponds to a first metric, and wherein the second vector corresponds to a second metric that is different from the first metric.

10. The computer-implemented method of claim 1, wherein the set of metrics data includes: (i) a sequence of time spent, (ii) a sequence of web page proportion, (iii) a sequence of events corresponding with respective web pages of the sequence of web pages, (iv) a set of web page load times, or (v) a set of exit link flags.

11. A system comprising:
one or more processors; and
one or more memories storing processor-executable instructions that, when executed by the one or more processors, cause the one or more processors to perform operations comprising:
receiving a sequence of web pages visited by a user;
applying a machine learning model to (i) the sequence of web pages and (ii) a set of metrics data corresponding to the sequence of web pages, wherein applying the machine learning model includes
generating one or more embeddings of web page identifiers associated with the sequence of web pages,
determining, by a first hidden layer of the machine learning model and for each respective embedding of the one or more embeddings, a first modified embedding based on respective cross-effects associated with one or more other embeddings of the one or more embeddings,
determining, by a second hidden layer of the machine learning model and for each respective first modified embedding, a second modified embedding based on the set of metrics data associated with a respective first modified embedding, and
outputting a user experience value for each second modified embedding; and
generating one or more data objects indicating one or more of the user experience values.

12. The system of claim 11, wherein the machine learning model is a long short-term memory (LSTM) network in combination with a transformer model.

13. The system of claim 12, wherein the first hidden layer and the second hidden layer are associated with the LSTM network, and applying the machine learning model further includes:
generating, by the transformer model, the one or more embeddings associated with the sequence of web pages.

14. The system of claim 11, wherein applying the machine learning model further includes:
determining, by a third hidden layer, a reduced dimension embedding for each second modified embedding, wherein the third hidden layer is a dense layer.

15. The system of claim 11, wherein applying the machine learning model further includes:
outputting, by an output layer, the user experience value for each second modified embedding by applying a sigmoid function, wherein the output layer is a dense layer.

16. The system of claim 11, wherein the machine learning model is a first machine learning model, and the instructions, when executed by the one or more processors, further cause the one or more processors to perform operations comprising:
applying a second machine learning model to (i) the user experience value, (ii) demographic data, and (iii) the set of metrics data corresponding to the sequence of web pages to output a user likelihood value.

17. The system of claim 16, wherein the second machine learning model is one or more of: (i) a trained random forest model, (ii) a Naïve Bayes model, (iii) a support vector machine (SVM) model, (iv) a logistic regression model, or (v) a gradient boosting model.

18. The system of claim 11, wherein the set of metrics data is a vector associated with an input layer to the machine learning model.

19. The system of claim 18, wherein the set of metrics data includes (i) a first vector associated with a first input layer and (ii) a second vector associated with a second input layer, wherein the first vector corresponds to a first metric, and wherein the second vector corresponds to a second metric that is different from the first metric.

20. One or more non-transitory computer-readable media storing processor-executable instructions that, when executed by one or more processors, cause the one or more processors to perform operations comprising:
receiving a sequence of web pages visited by a user;
applying a machine learning model to (i) the sequence of web pages and (ii) a set of metrics data corresponding to the sequence of web pages, wherein applying the machine learning model includes
generating one or more embeddings of web page identifiers associated with the sequence of web pages,
determining, by a first hidden layer of the machine learning model and for each respective embedding of the one or more embeddings, a first modified embedding based on respective cross-effects associated with one or more other embeddings of the one or more embeddings,
determining, by a second hidden layer of the machine learning model and for each respective first modified embedding, a second modified embedding based on the set of metrics data associated with a respective first modified embedding, and
outputting a user experience value for each second modified embedding; and
generating one or more data objects indicating one or more of the user experience values.
